(19) United States
(12) Patent Application Publication
(10) Pub. No.: US 2024/0346251 A1
(43) Pub. Date: Oct. 17, 2024

(54) TOPIC EVALUATION ENGINE FOR A MESSAGING SERVICE

(71) Applicant: Microsoft Technology Licensing, LLC, Redmond, WA (US)

(72) Inventors: Vu Le, Bellevue, WA (US); Quan NGUYEN, Redmond, WA (US); Siddharth UPPAL, Bothell, WA (US); Ankit GOVIL, Redmond, WA (US)

(21) Appl. No.: 18/134,310

(22) Filed: Apr. 13, 2023

(51) Int. Cl. G06F 40/30; G06F 9/445; G06F 40/289; G06N 20/00; H04L 51/214

(52) U.S. Cl. CPC G06F 40/30; G06F 9/44526; G06F 40/289; G06N 20/00; H04L 51/214

(57) ABSTRACT

Described herein is a topic evaluation engine that operates in connection with a messaging service by analyzing individual text-based messages, received during a text-based communication session, to identify various message characteristics of each text-based message, and/or to infer one or more topics to which each message relates. Each message that is determined to have a particular message characteristic is then forwarded to any application that previously subscribed with the messaging service to receive messages having the specific message characteristic. Similarly, each message that is associated with a specific topic is distributed to any application integrated with the messaging service that has previously subscribed with the messaging service to receive messages relating to the specific topic. The integrated applications can then process the message and provide enhanced functionality.

### TECHNICAL FIELD

The subject matter disclosed herein generally relates to a messaging service having a variety of integrated software solutions, such as add-on applications (apps) and software services, which provide to end-users enhanced functionality beyond the core functionality of the messaging service. More specifically, the subject matter relates to a topic evaluation engine that is integrated with the messaging service for analyzing and evaluating individual messages received at the messaging service to identify specific message characteristics, to identify one or more topics to which each message relates, or to identify some combination of a topic, message intent, and context for a message, so that each message can be selectively distributed or routed to an integrated software solution that has previously subscribed to receive topic-specific messages or messages having specific characteristics.

### BACKGROUND

Text-based messaging services, sometimes referred to as chat services, allow end-users to conduct text-based communication sessions that are one-to-one and one-to-many. For instance, in a one-to-one text-based communication session, a message sender will use a messaging application to generate and send a text-based message to a messaging application of a message recipient. Similarly, in a one-to-many context, a message that is communicated by a message sender may be delivered to multiple message recipients.

Many text-based messaging or chat services provide enhanced functionality by allowing for the integration of software-based applications (apps) and services (referred to broadly herein as integrated or add-on software solutions), including software solutions developed by third parties. These software solutions are integrated with the messaging service, such that one of their primary inputs is messages that are exchanged between participants in a communication session. The integrated software solutions process these messages to provide functionality that is supplemental to the core functionality of the messaging service.

### BRIEF DESCRIPTION OF THE DRAWINGS

Embodiments of the present invention are illustrated by way of example and not limitation in the figures of the accompanying drawings, in which:

FIG. 1 is a diagram illustrating an example user interface for a conventional messaging application that requires an end-user to explicitly identify an integrated software solution, in the body of a message, in order to invoke the integrated software solution for processing a message.

FIG. 2 is a block diagram illustrating a first example of how a conventional messaging service may distribute messages to one or more integrated software solutions, by requiring an end-user to explicitly identify an integrated software solution, in the body of a message.

FIG. 3 is a block diagram illustrating a second example of how a conventional messaging service may distribute messages to one or more integrated software solutions.

FIG. 4 is a diagram illustrating an example user interface for a messaging application having an integrated topic evaluation engine to facilitate the selective distribution of messages, based on an inferred topic of each message, consistent with embodiments of the present invention.

FIG. 5 is a block diagram showing the functional components of a messaging service having a topic evaluation engine for the selective distribution of messages to integrated software solutions, consistent with some embodiments of the present invention.

FIG. 6 is a diagram showing how a large language model (LLM) may be used in the analysis of incoming messages, for purposes of determining a topic, message intent and context data for the message, consistent with some embodiments.

FIG. 7 is a flow diagram illustrating various operations of a method or algorithm performed by a message service with a topic evaluation engine, consistent with embodiments of the present invention;

FIG. 8 is a block diagram illustrating a software architecture, which can be installed on any of a variety of computing devices to perform methods consistent with those described herein.

FIG. 9 is a system diagram illustrating an example of a computing device with which embodiments of the present invention might be implemented.

### DETAILED DESCRIPTION

Described herein are methods and systems for analyzing and evaluating text-based messages received at a messaging service to identify one or more message characteristics of a message, to identify one or more topics to which a message relates, or to identify a combination of topics, message intent, and message context for a message, so that each message can be selectively routed to a software application (app) or service that has subscribed to receive messages possessing specific message characteristics or specific message topics. In the following description, for purposes of explanation, numerous specific details are set forth to provide a thorough understanding of the various aspects of different embodiments of the present invention. It will be evident, however, to one skilled in the art, that the present invention may be practiced without all of these specific details.

To extend the core functionality of an online text-based messaging service, many messaging services provide some mechanism by which software apps and services, sometimes referred to as chatbot or bots, can be integrated with the online messaging service and configured to receive and process messages that are sent and/or received by end-users of the messaging service. Generally, one of two approaches have been used in distributing messages from the messaging service to these add-on software solutions that have been integrated with the messaging service.

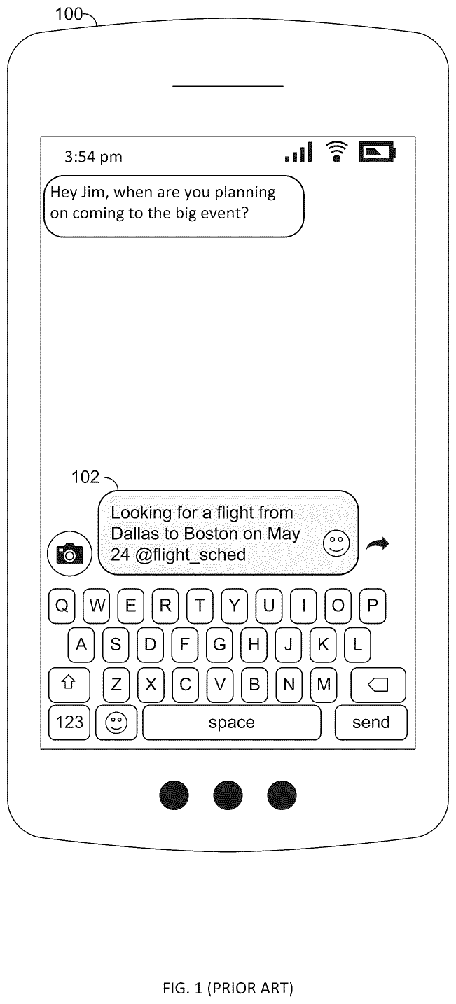

Consistent with a first conventional approach to distributing messages, a messaging service leverages message routing logic to route each message based on a tag, a keyword, an app identifier, or some other text uniquely identifying an app, as included in the body of the text-based message. By way of example. FIG. 1 illustrates an example user interface of a messaging application executing on a client device, which uses this first conventional approach to distributing messages. In this example, the end-user of the messaging application executing on the client device 100 has typed a message 102 to be communicated to another end-user via a messaging service. The message 102 includes the text, “@flight_sched.” In this instance, the text. “@flight_sched,” provided by the message sender is an explicit reference to a software app providing a service relating to flight scheduling. To invoke the flight scheduling application, the end-user has included in the body of the text-based message the specific tag or app identifier (e.g., “@flight_sched”) to invoke the flight scheduling service to process the message 102.

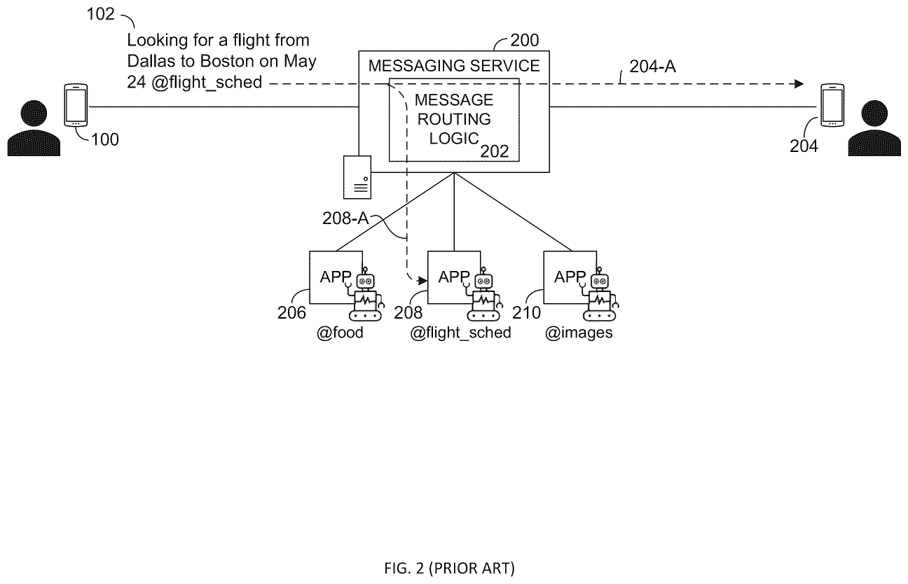

Continuing with the example, as illustrated in FIG. 2, the client device 100 sends the message 102 to the messaging service 200. As indicated by the line 204-A, the message routing logic 202 of the messaging service 200 routes the message 102 to a client device 204 of a message recipient, where the message is presented in a user interface to the message recipient. Simultaneously, the message routing logic 202 parses the message and identifies within the message the reference to the app or app identifier (e.g., “@flight_sched”) for the software app 208 providing the flight scheduling service. Accordingly, as shown by the line 208-A, the message routing logic 202 forwards the message 102 to the app 208 for further processing. In this case, the app 208 may process the message 102 and generate one or more airline flight recommendations, which are then presented in a user interface to the message sender. However, without the tag or app identifier being included in the text of the message 102, the messaging service 200 would not forward the message 102 to the flight scheduling app for processing.

With this first conventional approach to distributing messages, an end-user—specifically, a message sender—is required to identify a software app or service deliberately and explicitly by including in the body of a text message a specific reference. This is undesirable and disadvantageous for a variety of reasons. First, end-users may potentially have many apps or services available to them, and it may not be reasonable to expect each end-user to remember the functionalities of each software solution and in what context a specific software solution could or should be invoked. As many end-users of a messaging service may not be aware of specific scenarios for which an app or service may augment or improve their experience, many end-users may not remember or think to invoke a particular add-on software solution. Moreover, even when an end-user is aware of a particular add-on software solution, the end-user may not remember the tag, keyword or app identifier, that is required to be in the body of the text message in order to invoke the app. Additionally, in the context of a conversation that includes multiple messages being exchanged by multiple messaging participants, it may be burdensome for each end-user to add the relevant text (e.g., the app identifier) in the body of every message that is being sent. Furthermore, if an app can only be invoked by requiring a message sender to identify an app in the body of a text-based message, then an app can only be invoked by a message sender, and not for the benefit of a message recipient. This means, message recipients may not benefit from the additional functionality of certain apps, based on receiving messages. Finally, this first conventional message distribution technique undercuts the ability of an app to naturally detect conversational intent and seamlessly provide value in context without user initiation.

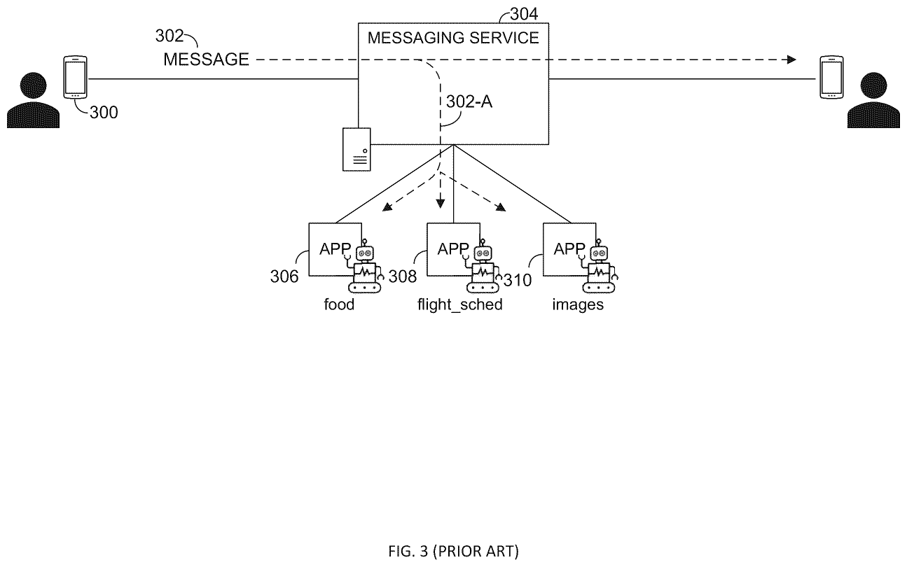

In a second conventional approach to distributing messages, as illustrated in FIG. 3, every app that has been configured to operate in connection with the messaging service receives all messages that are communicated as part of a communications session. For example, as illustrated in FIG. 3, a message sender is using a messaging application executing on a client device 300 to send a text-based message 302, via the messaging service 304, to a message recipient. In this example, three apps (306, 308 and 310) have been configured to operate in connection with the messaging service 304 to provide enhanced functionality. As indicated by the dashed line 302-A, when the message sender sends the text-based message 302, the message 302 is communicated to the message recipient and simultaneously communicated to each of the three integrated apps (306, 308 and 310). Accordingly, each of the three integrated apps receives the message, and each app must determine independently the relevance, if any, of the content of the message.

This second conventional approach to distributing messages from a messaging service to one or more add-on apps or services provides a way for these integrated software solutions to receive messages without the end-user having to explicitly identify the add-on software solution in the body of a message. However, this second conventional approach to message distribution is problematic for a number of other reasons. For example, each app or service may need to process a massive number of individual messages in order to, potentially, only act on a small number of messages that are relevant. This will result in wasteful network calls and processing time, leading to an increase in costs for developers and the entity operating the messaging infrastructure With this second approach, each application developer will also need to build advanced message processing intelligence into each app in order to process and evaluate all incoming messages. Furthermore, in an enterprise context, the wide scope of subject matter that may be conveyed with the various messages may cause data privacy concerns. Accordingly, an administrator of the messaging service may elect to not allow add-on apps by simply disabling the feature.

Of course, the two approaches to distributing messages may not be mutually exclusive. For example, a conventional messaging service may deploy both techniques, together. Accordingly, with a conventional messaging service, some add-on software apps and services may be configured to receive all messages, while other add-on software solutions may be configured to only receive messages that include a reference to a specific app identifier, as specified by the message sender.

Consistent with embodiments of the present invention, a messaging service includes an improved technique for distributing text-based messages to add-on software apps and services, referred to collectively as add-on or integrated software solutions Described herein is a messaging service that has an integrated topic evaluation engine. The topic evaluation engine includes message routing logic that leverages a subscription management service. When a software app or service is installed and configured to operate with the messaging service, the software app or service provides subscription configuration information to the subscription management service of the topic evaluation engine, where the subscription configuration information indicates specific topics and/or specific message characteristics, for which a software app or service should receive messages. When a message is received at the messaging service, the topic evaluation engine processes the message to determine one or more topics to which the message relates. The topic evaluation engine may also process the message to determine one or more message characteristics of the message. With some embodiments, a message may also be processed to determine a message intent, and/or a message context. Then, the message routing logic performs a look-up operation by requesting from the subscription management service the identity of any app or service that has previously subscribed to receive messages relating to the one or more topics, or messages having the one or more message characteristics. The received message is then forwarded to only those software apps or services that previously subscribed to receive messages that are related to the specific topic associated with the message, or messages having a specific message characteristic.

Embodiments of the present invention provide several technical advantages over the conventional techniques described above. For instance, end-users of the messaging service will receive the benefit of the enhanced functionality provided by the add-on software apps and services integrated with the messaging service, without having to specifically reference an app or service in the body of a text-based message. Moreover, software developers can focus efforts on providing enhanced functionality, without having to develop message processing intelligence for identifying messages having content relevant to the app or service, and for filtering out messages having content that is irrelevant. Other aspects and advantages of the various embodiments of the present invention will be readily appreciated from the description of the several figures that follows.

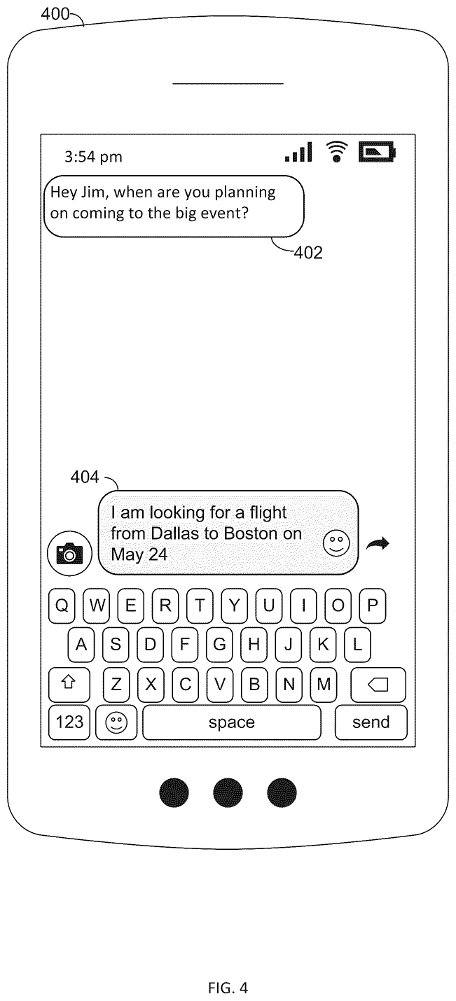

FIG. 4 is a diagram illustrating an example user interface for a messaging application that operates with a messaging service having an integrated topic evaluation engine to facilitate the selective distribution of messages to add-on software apps, based on an inferred topic of each message, consistent with embodiments of the present invention. As shown in FIG. 4, a client computing device 400 is presenting a user interface for a messaging application. An end-user of the messaging application has received a first message 402, and has prepared a second message 404 for sending as a reply to the first message 402. As illustrated in FIG. 4, in contrast with some conventional techniques, when preparing a message, the end-user, as a message sender, need not identify or refer to an app in the body of the text-based message in order to invoke the app. Instead, and as described in greater detail below, to benefit from the enhanced functionality of an add-on app integrated with the messaging service, an end-user need only authorize an installed app to receive and process messages. Once the app has been authorized, no further action is required of the end-user.

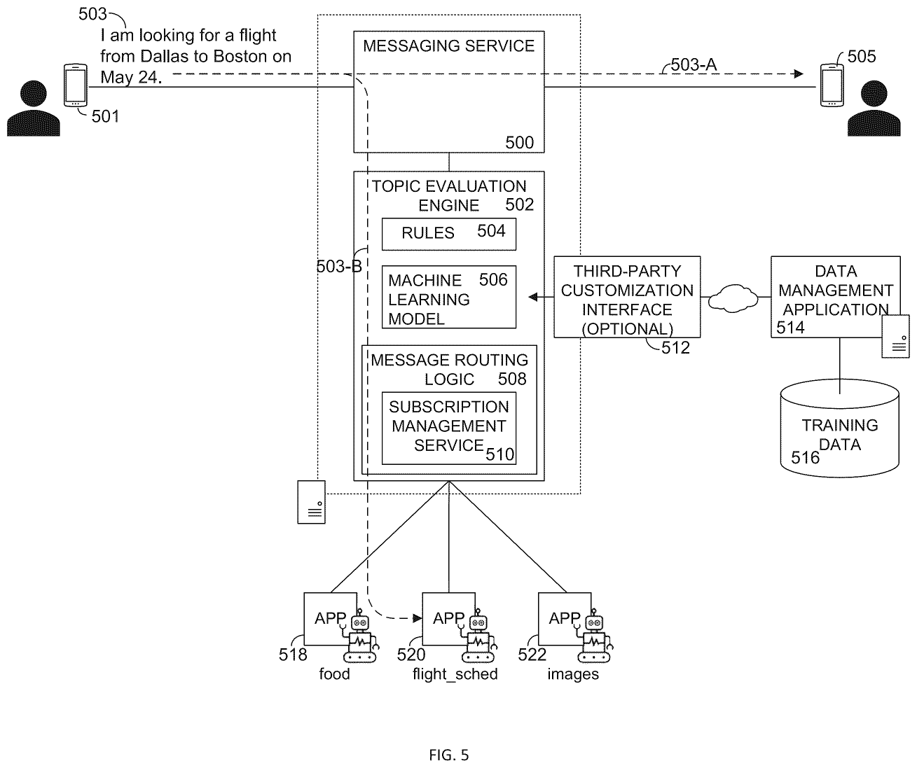

FIG. 5 is a block diagram showing the functional components of a messaging service 500 having a topic evaluation engine 502 to facilitate the selective distribution of messages to add-on software apps (e.g., apps 518, 520 and 522), consistent with some embodiments of the present invention. When a software app is installed and configured to operate with the messaging service 500, the software app leverages a configuration mechanism by which the software app provides subscription configuration information to a subscription management service 510 of the topic evaluation engine 502. The subscription configuration information for a software app identifies the specific topics or message characteristics that are relevant to the app, such that, when the topic evaluation engine 502 determines that a received message 404 relates to a topic to which an app has subscribed, the message relating to that topic, and the topic itself, are forwarded to the software app that previously subscribed to the topic. Similarly, if a software app has subscribed to receive messages having a specific message characteristic, when the topic evaluation engine receives and processes a message with the specific message characteristic, the message will be forwarded to the app that previously subscribed to receive messages having the specific message characteristic.

In general, each software app may subscribe to any of a number of predetermined topics that the topic evaluation engine 502 is capable of identifying. Similarly, each software app may subscribe to receive messages having any of a number of specific message characteristics that the topic evaluation engine is capable of identifying. With some embodiments, identifying a topic to which a message relates is generally accomplished with a machine learning model 506, using a supervised machine learning technique, such as a multilabel classification model. Identifying message characteristics is generally achieved using heuristic or rule-based techniques.

Consistent with some embodiments, the subscription configuration information for each software app is included in a configuration file associated with the software app, which in some instances may be an application manifest. Accordingly, with some embodiments, the configuration file will include subscription configuration information indicating the specific topics and message characteristics to which the software app is requesting a subscription. When a software app is first installed and executed, the relevant topic subscriptions for the software app can be stored as part of a conversation's app entitlements, and subsequently retrieved during the message distribution process (described further below).

Consistent with some embodiments, the subscription configuration information for a software app may be communicated to a subscription management service 510 of the topic evaluation engine 502 as part of a dynamic subscription approach. For instance, with some embodiments, a software app that has already been installed and is executing may dynamically make requests to the subscription management service 510, where each request includes subscription configuration information. In this scenario, each subscription request may be consistent with an API call, and a request may be a request to subscribe to a topic or message characteristic, or a request to unsubscribe from a topic or message characteristic.

Once a software app has been configured and has established a subscription to one or more topics, or a subscription for messages having one or more message characteristics, the topic evaluation engine will forward to the software app any message that is received that is determined to be related to a subscribed-to topic or any message having a specific subscribed-to message characteristic. By way of example, in FIG. 5, a text-based message 503 has been communicated from the client device 501 to the messaging service 500. As evidenced by the dashed line with reference 503-A, the message 503 is delivered to a message recipient 505. In addition, as evidenced by the dashed line 503-B, the message is forwarded to the topic evaluation engine 502.

The topic evaluation engine 502 includes rules 504 for processing incoming messages to identify within those messages various message characteristics. The rule-based analysis of messages may involve the parsing of the text included in the message to identify individual words and phrases, analysis of the structure of the message, regular expressions, and so forth. In general, the rules-based content analysis of messages results in the determination or identification of specific message characteristics of the message. Some examples of the various message characteristics that may be identified using the rules 504 and the rules-based approach include, but are not limited to:
identifying within a message a media content item other than text;
identifying within a message text representing a link (e.g., a hyperlink) to another resource;
identifying within a message text representing an address or mention (e.g., “@username”);
identifying within a message an emoji, icon or sticker;
identifying an occurrence of regular expression (e.g., Regex)
identifying within a message text representing a keyword included in a list of keywords.

In addition to processing each incoming message to identify various message characteristics, each incoming message may also be processed by one or more machine learning models 506 to identify or infer one or more topics to which each message relates. The machine learning model 506 may be a multilabel classifier that receives, as input, text from the text-based message, and generates, as output, a score for each topic of a plurality of topics. Accordingly, with some embodiments, the score assigned to or associated with a topic as output by the machine learning model 506 may be compared to a threshold. When the score for a specific topic exceeds the threshold, the topic associated with that score is presumed to be associated with the message. Consistent with some embodiments, a single threshold may be used for all topics, and for all apps. However, with some embodiments, different thresholds may be used for different topics, and different thresholds may be used for different apps. For example, with some embodiments, each add-on app may specify a threshold to be used for a specific topic as part of the subscription configuration information. By way of example, an add-on app may use a lower threshold for a specific topic, to ensure that more messages potentially relating to that topic are received by the app. Similarly, an add-on app may specify a higher threshold to ensure greater accuracy in the confidence that a specific message relates to a specific topic.

Consistent with some embodiments, the topic evaluation engine may provide a pre-trained model to identify some set of default topics, which can then be used by any add-on application. By way of example, and not limitation, some pre-defined topics may include:
Task
Scheduling
Date/Time
Question
Food
Location
   Of course, many other topics may also be determined or identified, by default, with one or more pre-trained machine learning models 506 provided by the entity operating the messaging service.

Consistent with some embodiments, in addition to processing each message with a machine learning model 506 to identify an inferred topic to which the message relates, one or more machine learning models may be leveraged to perform additional analysis, for instance, to identify a message intent of the message sender, and in some instances, message context or contextual data for the message. In this context, a message intent may be defined in relation to specific topics. For example, consider a simple message sent from one person to another—“Hey Jim, let's plan to meet on Thursday afternoon to discuss the latest revisions to the engineering specification for project Whizbang.” When this message is processed and analyzed by the topic evaluation engine, the message may be assigned to the topic, “task.” In this instance, the inferred message intent of the message may be “schedule meeting,” reflecting the intent of the message sender. The contextual data for this message, which is assigned to the topic, “task,” and has been assigned the message intent, “schedule meeting,” may be the relevant meeting participants, the day and/or time that the meeting is to be scheduled, and the subject matter of the meeting (e.g., project Whizbang). By identifying these specific values, the topic evaluation engine can provide a subscribing add-on app with valuable message intelligence data, allowing the developer of each add-on app to focus on implementing other aspects of the add-on application functionality.

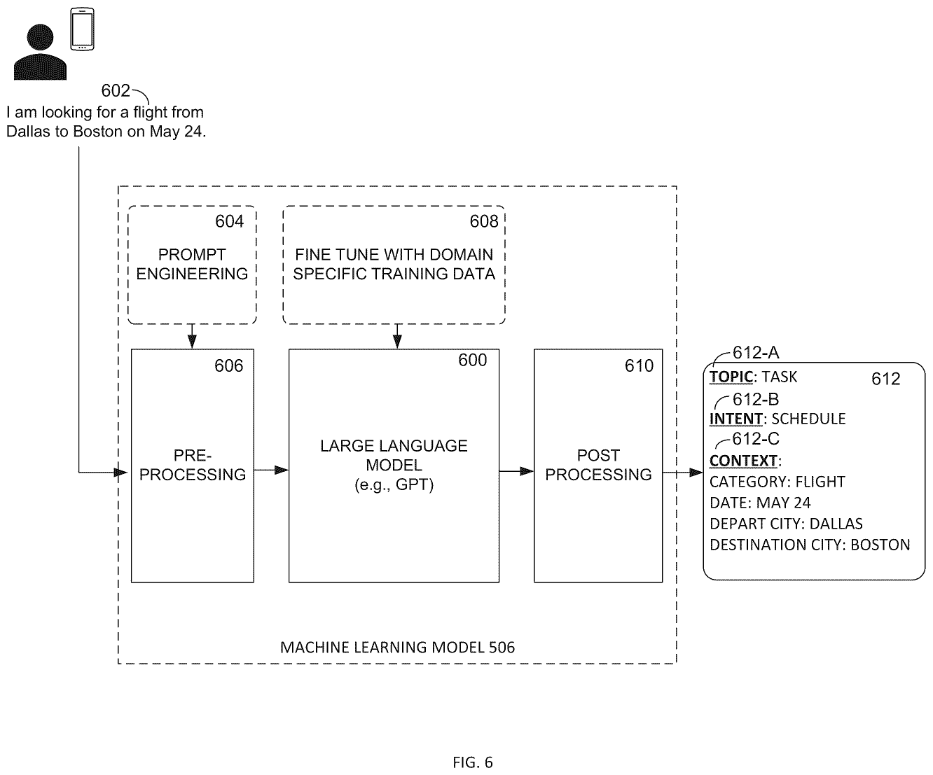

Accordingly, for some or all of the topics in a message taxonomy, the topic may have one or more message intents, and for each combination of a topic and a message intent, there may be any number of contextual data items. In some instances, specific topics may not have any related message intents, or contextual data. Similarly, some topics may have two, three, four or more relevant intents. That is, the message taxonomy may vary and may change significantly over time to serve the relevant add-on applications that are deployed with the messaging service. By processing each incoming message to identify for each incoming message, one or more topic values, one or more message intent values, and various contextual data values, the topic evaluation engine can not only route messages intelligently, based on the results of the message analysis, but can also provide subscribing apps with message intelligence. That is, the topic evaluation engine 502, in many instances, may replace all, or a substantial amount, of the message analysis that would otherwise need to be performed by each individual add-on application. The processing of messages to identify topic values, message intent values, and contextual data is described further in connection with FIG. 6, below.

Referring again to FIG. 5, consistent with some embodiments, a third-party customization interface 512 may be provided, for example, to allow for the training of customized, application-specific, machine learning models, which may serve to identify or determine custom (e.g., app specific) topics, message intent values, and message context values, beyond the capabilities of the default pre-trained machine learning model(s) 506. For example, as shown in FIG. 5, a third party may leverage a data management application 514 to make training data 516 available to one or more machine learning models. Subsequent to training a model with enterprise (e.g., third-party) and application specific training data, the model may be hosted via the messaging service platform, such that the model can be used by the topic evaluation engine 502 in processing and routing messages based on custom defined topics, custom defined message intent values, and custom defined message context values, that may be specific to a particular add-on software app.

FIG. 6 is a diagram illustrating an example of a topic evaluation engine that leverages a large language model (LLM) 600 for evaluating an incoming message 602 to generate for that message various values-such as a message topic 612-A, message intent 612-B, and contextual data 612-C-consistent with a message taxonomy, according to some examples. As illustrated in FIG. 6, consistent with some examples, the machine learning model 506 may be, or may include, a large language model (LLM) 600, such as those that utilize generative pre-trained transformers (GPT) Of course, in various embodiments, other variations of LLMs may be used, to include, for example, models based on ELMo (Embeddings for Language Models), ULMFiT (Universal Language Model Fine-Tuning), BERT (Bidirectional Encoder Representations from Transformers), or RoBERTa (Robustly Optimized BERT Pre-Training Approach). These are a few of the many different types of LLMs that may use a variety of architectures and training techniques to learn representations of natural language. While FIG. 6 and the relevant description involve an LLM model based on a GPT architecture, the various steps for customizing other LLM models to perform a specific task, such as generating values for a message taxonomy, as described herein, will be readily understood by those skilled in the art.

As shown in FIG. 6, to leverage an LLM 600 in performing a specific task—such as classifying a text-based message based on a message taxonomy—one of the necessary steps involves a task referred to as prompt engineering 604. In general, prompt engineering involves developing a set of input prompts or prompt templates that are designed to elicit a desired response from the LLM 600. These input prompts are carefully crafted to provide the LLM with the information it needs to generate accurate and relevant output responses. This could involve specifying the format of the prompt (e.g., a question, a statement, a command), selecting the appropriate vocabulary and syntax, and providing relevant context or background information, for the specific task. Once the prompt engineering has been completed and the relevant prompt templates have been developed, when a message 602 is received, a message pre-processing step 606 is applied to the message 602, during which the message may be parsed, and component parts of the message may be utilized in combination with the prompt template as input to the LLM 600.

As shown with reference number 608, in addition to prompt engineering 604, in many instances an LLM 600 may be fine-tuned to perform a specific task using domain specific training data. In this instance, the training data may be labeled messages, where the relevant component parts (e.g., specific text) of a message are labeled as representing a specific component from the message taxonomy (e.g., a topic, an intent, or a relevant contextual data value). Typically, the direct output from the LLM will be subject to some post processing logic, as shown in FIG. 6 with reference number 610. Finally, as shown in FIG. 6, the final output involves the various values for the different components of the taxonomy—for example, a topic value, an intent value, and one or more contextual data values. As shown in FIG. 6, the model 506 has generated only a single output. In various alternative embodiments, the model may generate multiple outputs or responses, and each output value may include a confidence value.

With some examples, multiple machine learning models may be used, such that a first model is used to identify an inferred topic, a second model is used to infer a message intent, and third model is used to identify contextual data for the message. In other instances, a message may be processed iteratively by the same one model—for example, in several steps, where each step involves analyzing a message for a different purpose, and the output from each iteration is provided as part of the input for a subsequent step. For instance, during a first iteration, the message may be analyzed to determine a topic. Then, during a second iteration, the message may be analyzed-provided as input to the model, with the identified topic—for purposes of identifying an inferred message intent. Accordingly, as shown in FIG. 6, the specific nature of the pre-processing 606 and post-processing 610 may be dependent upon the specific step in the overall process that is currently being conducted.

In the example presented in FIG. 6, the final output 612 includes values for a topic (e.g., “task”), an intent (e.g., “schedule”), and multiple values relating to context. In some instances, when an incoming message is analyzed, the model 506 may not be able to generate values for the intent, and/or the context. However, when a message is communicated to a subscribing add-on app, additional meta-data relating to the message may also be communicated, such as a conversation identifier, and end-user identifiers for messaging participants who are involved in the specific conversation. Accordingly, an application that has subscribed to receive messages relating to a particular topic may group messages by their common conversation identifier in order to aggregate message intelligence over time. For example, a subscribing add-on app may receive a first message, where the first message includes an indicating of the inferred topic, and an inferred message intent. In a second, third and fourth message, the subscribing add-on app may receive additional context data. Accordingly, as additional messages are received by the subscribing add-on application, the subscribing add-on application can associate messages that are part of the same conversation (e.g., linked by conversation identifier), and thus, aggregate relevant data relating to a conversation over time.

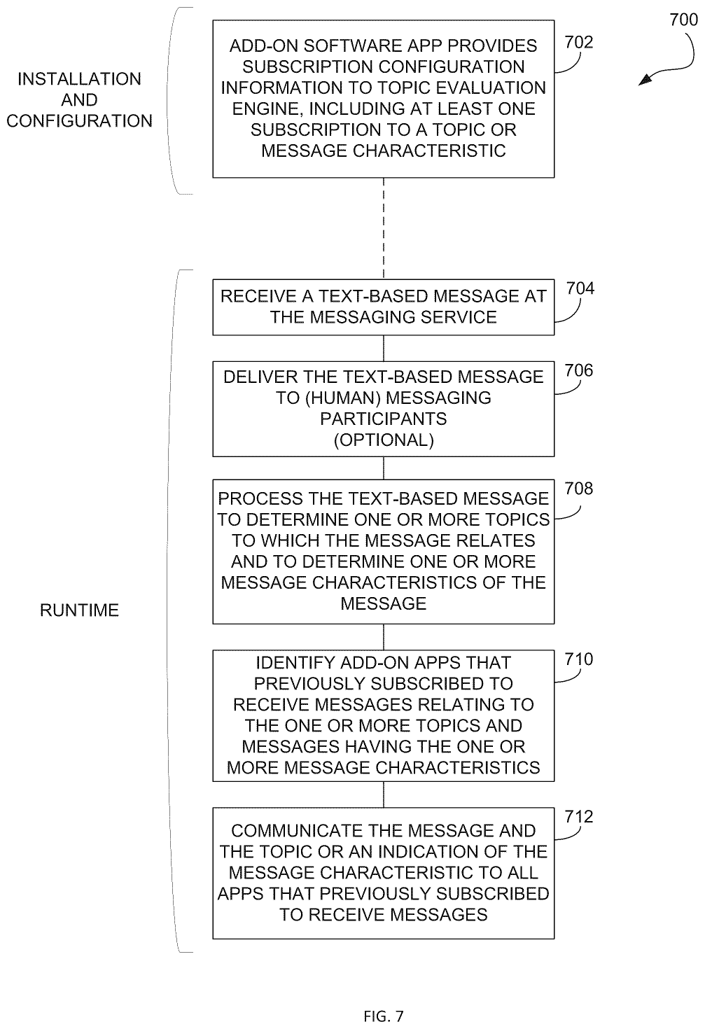

FIG. 7 is a flow diagram illustrating various operations of a method 700 or algorithm performed by a messaging service with a topic evaluation engine, consistent with embodiments of the present invention. As shown in FIG. 7, the various method operations are divided into two categories—a first category relating to add-on app installation and configuration operations, and second category of operations that occur at runtime. For example, the method 700 begins when an add-on application is initially installed. During installation, or sometime shortly thereafter, at method operation 702, the software app provides subscription configuration information to the topic evaluation engine. The subscription configuration information includes one or more subscription requests, where each request identifies a topic or message characteristics to which the software application is subscribing. This may be achieved via a configuration file that is read when the application is initially executed. Alternatively, the add-on software application may make one or more calls (e.g., API calls) to a subscription management service that is part of the topic evaluation engine, where each call includes a request for a subscription to a specific topic or specific message characteristic. With some embodiments, routing of messages may occur based on more advanced message analysis, and as such, in some instances, the subscription configuration information may specify various combinations of topics, message intents, and contextual data, such that only messages satisfying the relevant subscribed-to values will be forwarded to a subscribing add-on app.

Next, after an add-on app has been installed and configured, and the add-on app has subscribed to at least one topic or message characteristic, the method 700 continues at method operation 704 when, as part of a communication session, a text-based message is received at the messaging service. At method operation 706, the text-based message may (optionally) be delivered to one or more messaging participants that are designated as message recipients for the message. Next, at method operation 708, the text-based message is forwarded to the topic evaluation engine, which processes the text-based message to determine one or more topics to which the message relates and to determine one or more message characteristics of the message. In some instances, the message may also be processed to identify message intent values, and/or contextual data. With some embodiments, the determination of a topic is accomplished using one or more pre-trained machine learning models, whereas the identification of one or more message characteristics may be accomplished using heuristics or rules-based analysis of the message.

After the topic evaluation engine has determined the specific topic or topics to which the message relates, and the specific message characteristic(s) of the message, at method operation 710, the routing logic will query a data structure storing the subscription management data for the add-on apps, and determine which apps previously subscribed to receive messages relating to the one or more specific topics (e.g., related to the message), and messages having the one or more message characteristics. Finally, at method operation 712, the message and the topic to which the message relates are communicated to all add-on software apps that previously subscribed to the specific topic. Similarly, any add-on app that subscribed to a message characteristic of the message is sent the message and an indication of the message characteristic.

Although not shown in FIG. 7, when an add-on app receives a message as a result of having subscribed to a specific topic or message characteristic, the add-on app may perform any of a wide variety of actions, depending upon the nature and purpose of the add-on app. However, in general, the add-on app may process the message and then communicate data back to the messaging service, such that the data received from the add-on app can be presented to a messaging participant in a user interface of the messaging application. By way of example, the messaging application may present a user interface element (e.g., such as a button, or a link) allowing the end-user of the messaging application to take some specific action with respect to the add-on app, or a remote service associated with and related to the add-on app. For instance, a button or link may invoke a local application that is associated with the add-on app, or may invoke a web browser application. In some instances, the data communicated to the messaging service by an add-on app may be communicated to a messaging participant as a message, with or without interactive content in the body of the message. Moreover, the data communicated from the add-on app to the messaging service may be presented to a message sender, a message recipient, or all messaging participants in a conversation (e.g., the sender and all recipients). In some instances, the add-on application may process a received message, and then communicate data to a remote service. Accordingly, in some instances, from the perspective of the messaging participants, an add-on application may provide an asynchronous service, such that a messaging participant will only recognize the impact of the message processing at a later time when the messaging participant uses another application or service (e.g., other than the messaging service). Although the functionality and operation of the add-on apps will vary greatly, a few examples are presented below.

In one example, an add-on app be an application for automatically generating recommended calendar events and/or reminders, and so forth. Accordingly, the add-on app may subscribe to receive text-based messages that relate to a topic that is associated to scheduling, or messages having, as a message characteristic, text that expresses a date and/or time. When the add-on app receives the messages, the add-on app may process the messages to generate recommended calendar events (e.g., meetings, appointments, reminders, tasks, etc.). The recommendations may be presented to a messaging participant in a user interface of the messaging application, with one or more buttons that enable the end-user to quickly accept the recommendation and add relevant event data to a calendar. Alternatively, the add-on app may communicate data to a remote calendaring service, such that the messaging participants will view the relevant recommendation in another application (e.g., other than the messaging application) at a later time.

In another example, an add-on application may subscribe to receive messages that relate to a topic associated with food. The add-on application may then process messages for the purpose of generating restaurant recommendations relating to the specific types of food referenced in a message. These recommendations may be surfaced to the messaging participants in the messaging application, directly, for example in near real time during a messaging conversation. Alternatively, the restaurant recommendations may be surface to the end-user in a separate application.

In another example, an add-on application may provide or be associated with a flight scheduling or flight recommendation service, such that the add-on app subscribes to receive messages relating to scheduling, locations, and/or dates/times. The add-on app will process received messages by determining desired airline flight itineraries and then generating flight recommendations for presentation to the end-user.

These are but a few of the many possibilities for add-on applications that are integrated with a messaging service in a manner consistent with the various embodiments of the present invention

### Machine and Software Architecture

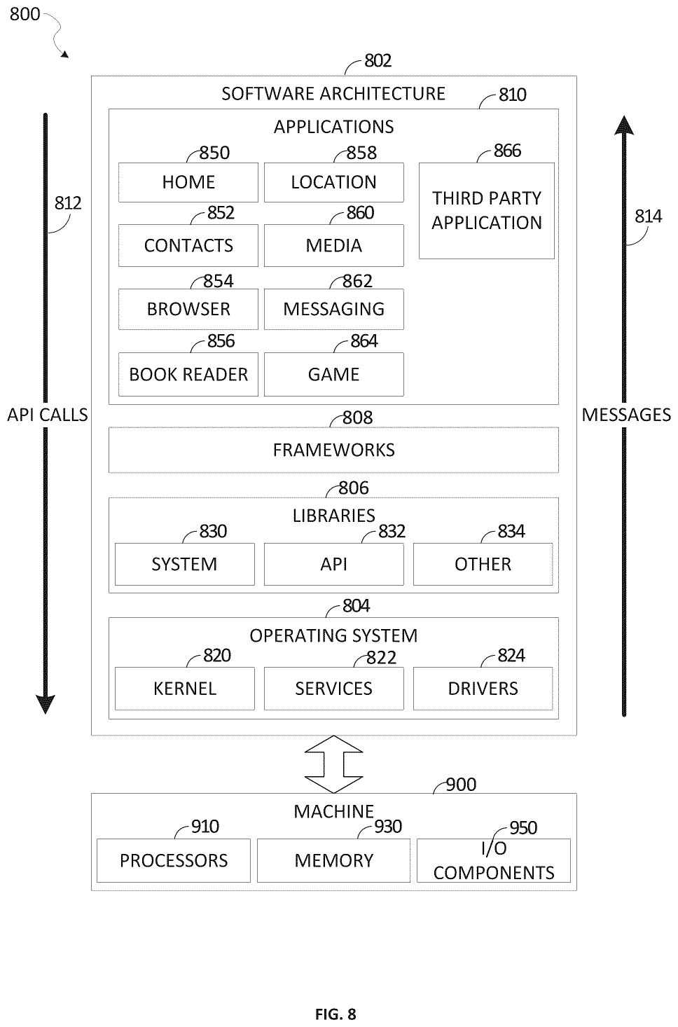

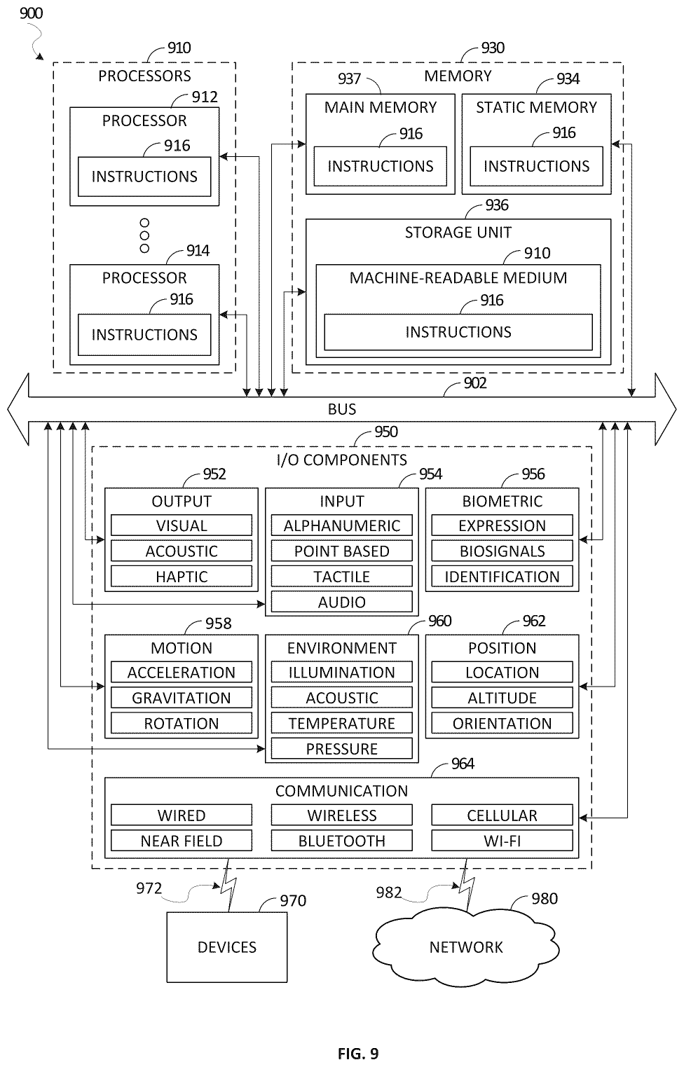

FIG. 8 is a block diagram 800 illustrating a software architecture 802, which can be installed on any of a variety of computing devices to perform methods consistent with those described herein. FIG. 8 is merely a non-limiting example of a software architecture, and it will be appreciated that many other architectures can be implemented to facilitate the functionality described herein. In various embodiments, the software architecture 802 is implemented by hardware such as a machine 900 of FIG. 9 that includes processors 910, memory 930, and input/output (I/O) components 950. In this example architecture, the software architecture 802 can be conceptualized as a stack of layers where each layer may provide a particular functionality. For example, the software architecture 802 includes layers such as an operating system 804, libraries 806, frameworks 808, and applications 810. Operationally, the applications 810 invoke API calls 812 through the software stack and receive messages 814 in response to the API calls 812, consistent with some embodiments.

In various implementations, the operating system 804 manages hardware resources and provides common services. The operating system 804 includes, for example, a kernel 820, services 822, and drivers 824. The kernel 820 acts as an abstraction layer between the hardware and the other software layers, consistent with some embodiments. For example, the kernel 820 provides memory management, processor management (e.g., scheduling), component management, networking, and security settings, among other functionality. The services 822 can provide other common services for the other software layers. The drivers 824 are responsible for controlling or interfacing with the underlying hardware, according to some embodiments. For instance, the drivers 824 can include display drivers, camera drivers, BLUETOOTH® or BLUETOOTH® Low Energy drivers, flash memory drivers, serial communication drivers (e.g., Universal Serial Bus (USB) drivers). Wi-Fi® drivers, audio drivers, power management drivers, and so forth.

In some embodiments, the libraries 806 provide a low-level common infrastructure utilized by the applications 810. The libraries 806 can include system libraries 830 (e.g., C standard library) that can provide functions such as memory allocation functions, string manipulation functions, mathematic functions, and the like. In addition, the libraries 806 can include API libraries 832 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 806 can also include a wide variety of other libraries 834 to provide many other APIs to the applications 810.

The frameworks 808 provide a high-level common infrastructure that can be utilized by the applications 810, according to some embodiments. For example, the frameworks 608 provide various GUI functions, high-level resource management, high-level location services, and so forth. The frameworks 808 can provide a broad spectrum of other APIs that can be utilized by the applications 810, some of which may be specific to a particular operating system 804 or platform.

In an example embodiment, the applications 810 include a home application 850, a contacts application 852, a browser application 854, a book reader application 856, a location application 858, a media application 860, a messaging application 862, a game application 864, and a broad assortment of other applications, such as a third-party application 866. According to some embodiments, the applications 810 are programs that execute functions defined in the programs. Various programming languages can be employed to create one or more of the applications 810, structured in a variety of manners, such as object-oriented programming languages (e.g., Objective-C, Java, or C++) or procedural programming languages (e.g., C or assembly language). In a specific example, the third-party application 866 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 866 can invoke the API calls 812 provided by the operating system 804 to facilitate functionality described herein.

FIG. 9 illustrates a diagrammatic representation of a machine 900 in the form of a computer system within which a set of instructions may be executed for causing the machine to perform any one or more of the methodologies discussed herein, according to an example embodiment Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. For example the instructions 916 may cause the machine 900 to execute any one of the methods or algorithmic techniques described herein. Additionally, or alternatively, the instructions 916 may implement any one of the systems described herein. The instructions 916 transform the general, non-programmed machine 900 into a particular machine 900 programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory 930, and I/O components 950, which may be configured to communicate with each other such as via a bus 902. In an example embodiment, the processors 910 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 912 and a processor 914 that may execute the instructions 916. The term “processor” is intended to include multi-core processors that may comprise two or more independent processors (sometimes referred to as “cores”) that may execute instructions contemporaneously. Although FIG. 6 shows multiple processors 910, the machine 900 may include a single processor with a single core, a single processor with multiple cores (e.g., a multi-core processor), multiple processors with a single core, multiple processors with multiples cores, or any combination thereof.

The memory 930 may include a main memory 932, a static memory 934, and a storage unit 936, all accessible to the processors 910 such as via the bus 902. The main memory 930, the static memory 934, and storage unit 936 store the instructions 916 embodying any one or more of the methodologies or functions described herein. The instructions 916 may also reside, completely or partially, within the main memory 932, within the static memory 934, within the storage unit 936, within at least one of the processors 910 (e.g., within the processor's cache memory), or any suitable combination thereof, during execution thereof by the machine 900.

The I/O components 950 may include a wide variety of components to receive input, provide output, produce output, transmit information, exchange information, capture measurements, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 6. The I/O components 950 are grouped according to functionality merely for simplifying the following discussion and the grouping is in no way limiting. In various example embodiments, the I/O components 950 may include output components 952 and input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 950 may include biometric components 956, motion components 958, environmental components 960, or position components 962, among a wide array of other components. For example, the biometric components 956 may include components to detect expressions (e.g., hand expressions, facial expressions, vocal expressions, body gestures, or eye tracking), measure bio-signals (e.g., blood pressure, heart rate, body temperature, perspiration, or brain waves), identify a person (e.g., voice identification, retinal identification, facial identification, fingerprint identification, or electroencephalogram-based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 962 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via a coupling 982 and a coupling 972, respectively. For example, the communication components 964 may include a network interface component or another suitable device to interface with the network 980. In further examples, the communication components 964 may include wired communication components, wireless communication components, cellular communication components. Near Field Communication (NFC) components, Bluetooth® components (e.g., Bluetooth® Low Energy), Wi-Fi® components, and other communication components to provide communication via other modalities. The devices 970 may be another machine or any of a wide variety of peripheral devices (e.g., a peripheral device coupled via a USB).

Moreover, the communication components 964 may detect identifiers or include components operable to detect identifiers. For example, the communication components 964 may include Radio Frequency Identification (RFID) tag reader components. NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix. Dataglyph. MaxiCode, PDF417, Ultra Code. UCC RSS-2D bar code, and other optical codes), or acoustic detection components (e.g., microphones to identify tagged audio signals). In addition, a variety of information may be derived via the communication components 964, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 930, 932, 934, and/or memory of the processor(s) 910) and/or storage unit 936 may store one or more sets of instructions and data structures (e.g., software) embodying or utilized by any one or more of the methodologies or functions described herein. These instructions (e.g., the instructions 916), when executed by processor(s) 910, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks, magneto-optical disks; and CD-ROM and DVD-ROM disks. The terms “machine-storage media,” “computer-storage media.” and “device-storage media” specifically exclude carrier waves, modulated data signals, and other such media, at least some of which are covered under the term “signal medium” discussed below.

### Transmission Medium

In various example embodiments, one or more portions of the network 980 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 980 or a portion of the network 980 may include a wireless or cellular network, and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., HTTP). Similarly, the instructions 916 may be transmitted or received using a transmission medium via the coupling 972 (e.g., a peer-to-peer coupling) to the devices 070. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 916 for execution by the machine 900, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A computer-implemented method, performed by a messaging service hosted by one or more server computers configured to operate with a plurality of add-on software solutions interfacing with the messaging service, the method comprising:
receiving subscription configuration information for a first add-on software solution in the plurality of add-on software solutions, the subscription configuration information indicating a request to subscribe to messages relating to a first topic or having a first message characteristic;
storing the subscription configuration information for the first add-on software solution via a data structure;
receiving a first text-based message from a client computing device of a messaging participant; and
processing the first text-based message by:
using a pre-trained machine learning model to determine the first text-based message is related to the first topic or analyzing the first text-based message to determine the first text-based message has the first message characteristic;
determining, based on the data structure, that the first add-on software solution of the plurality of add-on software solutions has previously subscribed to receive text-based messages related to the first topic or having the first message characteristic;
sending to the first add-on software solution the first text-based message and the first topic or an indication of the first message characteristic; and
responsive to receiving data from the first add-on software solution, causing a client computing device of a messaging participant to perform a designated function according to the received data from the first add-on software solution.

2. The computer-implemented method of claim 1, wherein the pre-trained machine learning model is a large language model (LLM), the method further comprising:
processing the first text-based message by:
using the LLM to determine for the first text-based message a value representing a message intent for the first text-based message and one or more contextual data values associated with the first topic and the value representing the message intent.

3. The computer-implemented method of claim 1, wherein receiving subscription configuration information for the first add-on software solution further comprises:
receiving the subscription configuration information via a subscription request from the first add-on software solution at a subscription management service of the messaging service, wherein the subscription management service is configured to dynamically process subscription requests received from add-on software solutions, the subscription requests including i) requests to subscribe to messages relating to a topic or having a message characteristic, and ii) requests to unsubscribe to messages relating to a topic or having a message characteristic.

4. The computer-implemented method of claim 1, wherein receiving subscription configuration information for the first add-on software solution further comprises:
reading the subscription configuration information from a configuration file for the first add-on software solution.

5. The computer-implemented method of claim 1, wherein using the pre-trained machine learning model to determine the first text-based message is related to the first topic further comprises:
providing to the pre-trained machine learning model, as input, text of the first text-based message, and receiving from the pre-trained machine learning model, as output, a score for each topic of a plurality of topics, including the first topic; and
determining the first text-based message is related to the first topic by determining that the score for the first topic, as output by the pre-trained machine learning model, exceeds a threshold;
wherein the threshold is a topic-specific threshold defined for the first add-on software solution and provided via the subscription configuration information for the first add-on software solution.

6. The computer-implemented method of claim 5, wherein analyzing the first text-based message to identify a message characteristic of a plurality of message characteristics comprises:
analyzing the first text-based message to identify within the first text-based message any one or more of:
a media content item other than text;
text representing a link to another resource;
text representing an address or mention;
an emoji, icon or sticker; or
text representing a keyword included in a list of keywords.

7. The computer-implemented method of claim 1, wherein receiving data from the first add-on software solution, comprises:
receiving data representing a recommendation for presentation to the messaging participant via a user interface, wherein the recommendation has been generated by the first add-on software solution processing the first text-based message, the recommendation relating to any one of:
a restaurant offering food associated with the first topic;
a store offering a product associated with the first topic; or
a service provided by a company, where the service is associated with the first topic.

8. The computer-implemented method of claim 1, wherein receiving data from the first add-on software solution further comprises one of:
receiving data for presenting to a messaging participant a recommended calendar event to be added to a calender;
receiving data for presenting to a messaging participant a reminder; or
receiving data for presenting to a messaging participant a task or to-do item.

9. The computer-implemented method of claim 1, further comprising:
receiving subscription configuration information for a second add-on software solution in the plurality of add-on software solutions, the subscription configuration information for the second add-on software solution indicating a request to subscribe to messages relating to a second topic or having a second message characteristic;
storing the subscription configuration information for the second add-on software solution via a data structure;
receiving a second text-based message from a client computing device of a messaging participant; and
processing the second text-based message by:
using the pre-trained machine learning model to determine the second text-based message is related to the second topic or analyzing the second text-based message to determine the second text-based message has the second message characteristic;
determining, based on the data structure, that i) the second add-on software solution of the plurality of add-on software solutions has not previously subscribed to receive text-based messages related to the first topic or having the first message characteristic, and ii) the second add-on software solution of the plurality of add-on software solutions has previously subscribed to receive text-based messages related to the second topic or having the second message characteristic; and
sending to the second add-on software solution the second text-based message and the second topic or an indication of the second message characteristic, without sending to the second add-on software solution the first text-based message and the first topic or an indication of the first message characteristic.

10. A system providing a messaging service configured to operate with a plurality of integrated software solutions, including software applications and software services, the system comprising:
at least one processor for executing instructions;
at least one memory storage device storing instructions thereon, which, when executed by the at least one processor, cause the system to perform operations comprising:
receiving subscription configuration information for a first software solution in the plurality of software solutions, the subscription configuration information indicating a request to subscribe to messages relating to a first topic or having a first message characteristic;
storing the subscription configuration information for the first software solution via a data structure;
receiving a first text-based message from a client computing device of a messaging participant; and
processing the first text-based message by:
using a pre-trained machine learning model to determine the first text-based message is related to the first topic or analyzing the first text-based message to determine the first text-based message has the first message characteristic;
determining, based on the data structure, that the first software solution of the plurality of software solutions has previously subscribed to receive text-based messages related to the first topic or having the first message characteristic;
sending to the first software solution the first text-based message and the first topic or an indication of the first message characteristic; and
responsive to receiving data from the first software solution, causing a client computing device of a messaging participant to perform a designated function according to the received data from the first software solution.

11. The system of claim 10, wherein the pre-trained machine learning model is a large language model (LLM), the operations further comprising:
processing the first text-based message by:
using the LLM to determine for the first text-based message a value representing a message intent for the first text-based message and one or more contextual data values associated with the first topic and the value for the message intent.

12. The system of claim 10, wherein receiving subscription configuration information for the first software solution further comprises:
receiving the subscription configuration information via a subscription request from the first software solution at a subscription management service of the messaging service, wherein the subscription management service is configured to dynamically process subscription requests received from software solutions, the subscription requests including i) requests to subscribe to messages relating to a topic or having a message characteristic, and ii) requests to unsubscribe to messages relating to a topic or having a message characteristic.

13. The system of claim 10, wherein receiving subscription configuration information for the first software solution further comprises:
reading the subscription configuration information from a configuration file for the first software solution.

14. The system of claim 10, wherein using the pre-trained machine learning model to determine the first text-based message is related to the first topic further comprises:
providing to the pre-trained machine learning model, as input, text of the first text-based message, and receiving from the pre-trained machine learning model, as output, a score for each topic of a plurality of topics, including the first topic; and
determining the first text-based message is related to the first topic by determining that the score for the first topic, as output by the pre-trained machine learning model, exceeds a threshold;
wherein the threshold is a topic-specific threshold defined for the first software application and provided via the subscription configuration information for the first software solution.

15. The system of claim 14, wherein analyzing the first text-based message to identify a message characteristic of a plurality of message characteristics comprises:
analyzing the first text-based message to identify within the first text-based message any one or more of:
a media content item other than text;
text representing a link to another resource;
text representing an address or mention;
an emoji, icon or sticker; or
text representing a keyword included in a list of keywords.

16. The system of claim 10, wherein receiving data from the first software solution further comprises:
receiving data representing a recommendation for presentation to the messaging participant via a user interface, wherein the recommendation has been generated by the first software solution processing the first text-based message, the recommendation relating to any one of:
a restaurant offering food associated with the first topic;
a store offering a product associated with the first topic; or
a service provided by a company, where the service is associated with the first topic.

17. The system of claim 10, wherein receiving data from the first software solution further comprises any one of:
receiving data for presenting to a messaging participant a recommended calendar event to be added to a calender;
receiving data for presenting to a messaging participant a reminder; or
receiving data for presenting to a messaging participant a task or to-do item.

18. The system of claim 10, wherein the operations further comprise:
receiving subscription configuration information for a second software solution in the plurality of software solutions, the subscription configuration information for the second software solution indicating a request to subscribe to messages relating to a second topic or having a second message characteristic;
storing the subscription configuration information for the second software solution via a data structure;
receiving a second text-based message from a client computing device of a messaging participant; and
processing the second text-based message by:
using the pre-trained machine learning model to determine the second text-based message is related to the second topic or analyzing the second text-based message to determine the second text-based message has the second message characteristic;
determining, based on the data structure, that i) the second software solution of the plurality of software solutions has not previously subscribed to receive text-based messages related to the first topic or having the first message characteristic, and ii) the second software solution of the plurality of software solutions has previously subscribed to receive text-based messages related to the second topic or having the second message characteristic; and
sending to the second software solution the second text-based message and the second topic or an indication of the second message characteristic, without sending to the second software solution the first text-based message.

19. A system providing a messaging service configured to operate with a plurality of software applications or software services interfacing with the messaging service, the system comprising:
means for receiving subscription configuration information for a first software application or first software service in the plurality of software applications or software services, the subscription configuration information indicating a request to subscribe to messages relating to a first topic or having a first message characteristic;
means for storing the subscription configuration information for the first software application or first software service via a data structure;
means for receiving a first text-based message from a client computing device of a messaging participant; and
means for processing the first text-based message by:
using a pre-trained machine learning model to determine the first text-based message is related to the first topic or analyzing the first text-based message to determine the first text-based message has the first message characteristic;
determining, based on the data structure, that the first software application or first software service of the plurality of software applications or software services has previously subscribed to receive text-based messages related to the first topic or having the first message characteristic;
sending to the first software application or first software service the first text-based message and the first topic or an indication of the first message characteristic; and
receiving, from the first software application or first software service, data for use in updating a user interface of an application executing at a client computing device of a messaging participant.

20. The system of claim 19, further comprising:
means for using a large language model (LLM) to determine for the first text-based message a value representing a message intent for the first text-based message and one or more contextual data values associated with the first topic and the message intent.
